(19) United States
(12) Patent Application Publication
(10) Pub. No.: US 2004/0154083 A1
(43) Pub. Date: Aug. 12, 2004

(54) Sports pad closure system with integrally molded hooks

(76) Inventor: Henry J. McVicker, Naples, FL (US)

Correspondence Address: JONES DAY, 77 WEST WACKER, CHICAGO, IL, 60601-1692, US

(21) Appl. No.: 10/744,890

(22) Filed: Dec. 23, 2003

Related U.S. Application Data
(60) Provisional application No. 60/436,068, filed on Dec. 23, 2002.

(51) Int. Cl. A62B 17/00; G21F 3/02; F41H 1/00

(52) U.S. Cl. 2/455

(57) ABSTRACT

An article of protective sports gear, such as a chest pad, knee pad, shin guard, wrist guard, or the like, is provided with a closure system comprising an injection molded plastic member having a field of integrally molded hooks, the field of hooks being releasably engageable by a cooperative loop-bearing member.

This application claims the benefit of provisional patent application Serial No. 60/436,068, filed Dec. 23, 2002, under 35 U.S.C. § 119.

### FIELD OF THE INVENTION

This invention relates to a novel sports pad closure system that uses hook and loop fasteners to secure different kinds of sports pads. In particular, the hook portion is integrally molded into a plastic portion of the sports pad, thereby eliminating the need for a separate and distinct hook portion that would otherwise have to be attached to the sports pad in a separate manufacturing step.

### BACKGROUND OF THE INVENTION

Hook and loop fasteners, such as those sold under the trademark VELCRO, have been used for many years in different products. Such hook and loop fasteners generally comprise two components. Each component has a flexible backing material having a surface thereon. One surface comprises a field of resilient hooks, while the other comprises a short-pile, looped fabric. As the two fastening surfaces are pressed together, the hooks releasably engage the loops, thus releasably holding the fastening materials together. The fastening surfaces are separated by pulling the fastening materials apart with sufficient force to cause the resilient hooks to straighten sufficiently to come out of engagement with the loops.

There are commercially available sports pads that use hook and loop fasteners in lieu of laces, buckles, or other securing means. The typical application has one or more straps containing both hook and loop sections that pass through a D-ring and back on to itself to secure the sports pads. Such sports pads include knee guards, elbow guards, and wrist guards such as are used by in-line skaters, shin guards for soccer players, shoulder pads for football and hockey players, and the like. All of the prior methods of using hook and loop fasteners to fasten sports pads require the use of a separate hook section that has to be glued, stitched or fastened in some way to the main body of the sports pad or its parts. The need for a separate hook section adds to the total number of parts needed and increases the complexity of the prior art. Also, there are additional labor costs involved in attaching the hook section to the sports pad.

It is thus one object of the invention to provide a hook and loop sports pad fastening system that is simpler in construction than prior art systems.

It is another object of the invention to provide a hook and loop sports pad fastening system that requires less time and labor to manufacture than prior art systems.

It is still another object of the invention to provide a hook and loop sports pad fastening system that can reduce or eliminate adhesives or stitching of the fastening system components.

It is yet another object of the invention to provide a hook and loop fastening system that is easier for the wearer to operate than prior art systems.

Other objects of and advantages of the invention will become apparent during the course of the detailed description that is part of this application.

### SUMMARY OF THE INVENTION

The present invention relates to a novel sports pad closure system comprising a hook bearing member and a loop bearing member to secure the sports pad. In a preferred embodiment of the invention, the hook bearing member comprises a field of spaced rows of hooks, preferably along the length of the hook bearing member. However, unlike prior art in the field, the hook bearing member in the present invention is integrally injection-molded into a plastic portion of the sports pad. Optionally, the sports pad closure system also may feature a D-ring or slot through which the loop-bearing member might be threaded pass before engaging the field of hooks, and in one embodiment the D-ring or formed slot can be integrally formed in a portion of the plastic sports pad. The closure system may comprise one or more separate parts that are attached to the sports pad during the assembly process, or in some cases, may be made integrally with the sports pad itself, eliminating the need for additional subassembly parts.

A cooperative loop bearing member or strap engages the integrally molded hooks, thereby securing the sports pad to the user. The loop bearing member or strap may include a retaining tab designed to prevent it from pulling back through the D-ring or slot when the closure system is released. This keeps the loop bearing member in a ready position, eliminating the need to guide it through the D-ring or slot each time. The retaining tab may be formed either integrally with the loop bearing member, or separately as an additional structure. The loop bearing member may be attached to the sports pad by conventional means which include sewing, welding, laminating or adhesives. It may also be attached to the sports pad by engagement to integrally molded hooks.

The thermoplastic material, preferably polypropylene, used for injection-molding the integrally-formed hooks has a memory sufficient to cause the hooks to return substantially to their original position after being removed from the mold, and yet has sufficient flexibility to allow the hooks to bend during removal from the mold and during engagement and release with the attached strap loops. The hooks could be molded by the method described in U.S. Pat. No. 5,656,226, which is incorporated here by reference.

In the present invention, by virtue of the hooks being integrally molded into the closure system by injection molding, the part can have a variable thickness to meet specific design criteria. For example, some parts of the sports pad may be thicker to provide greater protection to the wearer while other parts may be thinner to provide greater flexibility to conform to the individual user.

### BRIEF DESCRIPTION OF THE DRAWINGS

These and other objects of the present invention will be more fully understood in conjunction with the detailed description and the accompanying drawings in which like numerals represent like elements and in which:

FIG. 1 is a view of a hockey shoulder and body pad assembly having closure systems of the instant invention;

FIG. 2 is a view of a hockey knee and shin guard having a closure system of the instant invention;

FIG. 3 is a view of a hockey elbow guard having a closure system of the instant invention;

FIG. 4 is a view of a football shoulder and body pad having closure systems of the instant invention;

FIG. 5 is a wrist guard having closure systems of the instant invention; and

FIG. 6 is a view of a knee pad having closure systems of the instant invention.

### DETAILED DESCRIPTION OF THE DRAWINGS

The novel closure system is described herein as used with many kinds of sports pads that include a plastic part and that use hook and loop fasteners. The hooks are integrally molded into the plastic part, rather than being separately manufactured and then secured to the plastic part in a separate manufacturing step. The hooks can be single tipped hooks or double tipped hooks. The hooks can all face in the same direction, or in alternating directions, or in any pattern that is desirable for a particular end use.

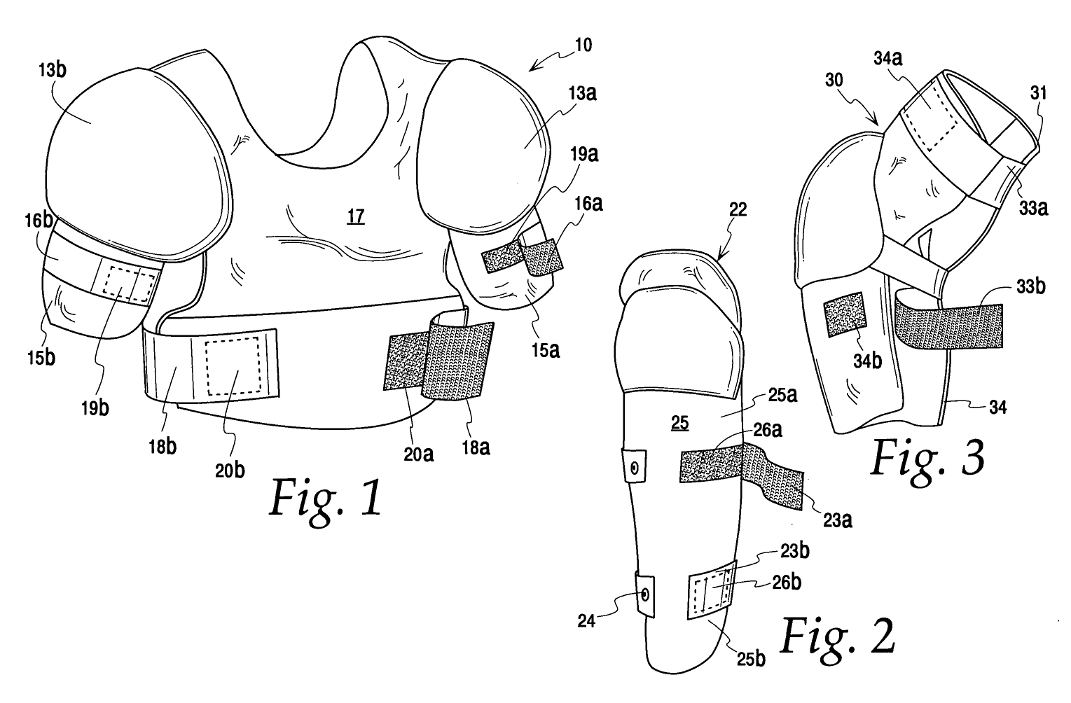

FIG. 1 illustrates an embodiment of a hockey shoulder and body pad assembly 10 having closure systems of the instant invention. As is known in the art, such pad assemblies typically include molded plastic shoulder caps 13a, 13b, molded plastic upper arm caps 15a, 15b, and a molded plastic chest protector 17. Such a pad assembly can be secured to the wearer by loop bearing members 16a, 16b securing upper arm caps 15a, 15b respectively about the upper arms, and loop bearing members 18a, 18b extending from the back around either side to the front lower region of chest protector 17. In prior art devices, the fields of hooks are provided as extruded hook bearing straps applied to the pad assembly by adhesives, stitching, or the like. In accordance with the invention, molded parts 15a, and 15b, are provided at selected predetermined locations thereon with one or more fields of integrally molded hooks 19a, 19b. In the illustration of FIG. 1, loop bearing member 16a is shown in the unsecured position relative to field of hooks 19a, and loop bearing member 16b is shown in the secured position with respect to field of hooks 19b, which is indicated by phantom lines as being beneath loop bearing member 16b. Further in accordance with the invention, molded part 17 is provided at selected predetermined locations thereon with one or more fields of integrally molded hooks 20a, 20b. In the illustration of FIG. 1, loop bearing member 18a is shown in the unsecured position relative to field of hooks 20a, and loop bearing member 18b is shown in the secured position with respect to field of hooks 20b, which is indicated by phantom lines as being beneath loop bearing member 18b. Each loop bearing member 16a, 16b, 18a, 18b can be secured at its opposite end by another field of hooks, not shown, molded into the appropriate position on the rear of the arm caps 15a, 15b, and the back part of the shoulder and body pad assembly 10, respectively. Alternatively, loop bearing members 16a, 16b, 18a, and 18b can be bonded at their opposite ends to the rear of the arm caps 15a, 15b, and the back part of the shoulder and body pad assembly 10, respectively by adhesives, laminating, welding, mechanical means such as rivets or stitching, or other equivalent means.

FIG. 2 illustrates an embodiment of a hockey knee and shin guard 22 having a closure system in accordance with the instant invention. Knee and shin guard 22 includes a shin guard 25 of molded plastic. Each loop bearing member 23a, 23b can be secured at its opposite end by another field of hooks, not shown, molded into the appropriate position on one side of the front of shin guard 25. Alternatively, loop bearing members 23a, 23b can be bonded at their opposite ends to one side of the front of shin guard 25 by adhesives, laminating, welding, mechanical means such as stitching or rivets, or other equivalent means. In the illustrated embodiment, loop bearing members 23a, 23b, are shown as being attached by rivets 24 to upper shin guard portion 25a and lower shin guard portion 25b, respectively. Upper shin portion 25a and lower shin portion 25b are each provided with a field of integrally molded hooks 26a, 26b. In the illustration of FIG. 2, loop bearing member 23a is shown in the unsecured position relative to field of hooks 26a, and loop bearing member 23b is shown in the secured position with respect to field of hooks 26b, which is indicated by phantom lines as being beneath loop bearing member 23b. The user applies the shin guard to the leg by placing the shin guard on the front of the shin and wrapping each strap behind the leg so that the loop bearing portion extends around to the front of the leg to engage the corresponding field of hooks. It will be appreciated that a shin guard such as for soccer players or other sports can be constructed in substantially the same manner.

FIG. 3 illustrates an embodiment of a hockey elbow guard 30 having a closure system in accordance with the instant invention. Elbow guard 30 includes an upper arm portion 31 and a forearm portion 32 each made of molded plastic, and each provided with a loop bearing member 33a, 33b, respectively. Each loop bearing member 33a, 33b can be secured at its opposite end by another field of hooks, not shown, molded into the appropriate position on upper arm portion 31 and forearm portion 32, respectively. Alternatively, loop bearing members 33a, 33b, can be bonded at their opposite ends to upper arm portion 31 and forearm portion 32 by adhesives, laminating, welding, mechanical means such as rivets or stitching, or other equivalent means.

Upper arm portion 31 and forearm portion 32 are each provided with a field of integrally molded hooks 34a, 34b. In the illustration of FIG. 3, loop bearing member 33a is shown in the secured position relative to field of hooks 34a, which is indicated by phantom lines as being beneath loop bearing member 33a, and loop bearing member 33b is shown in the unsecured position with respect to field of hooks 33b. It will be appreciated that other elbow guards can be constructed in substantially the same manner for use in sports such as in-line skating, skateboarding, and the like.

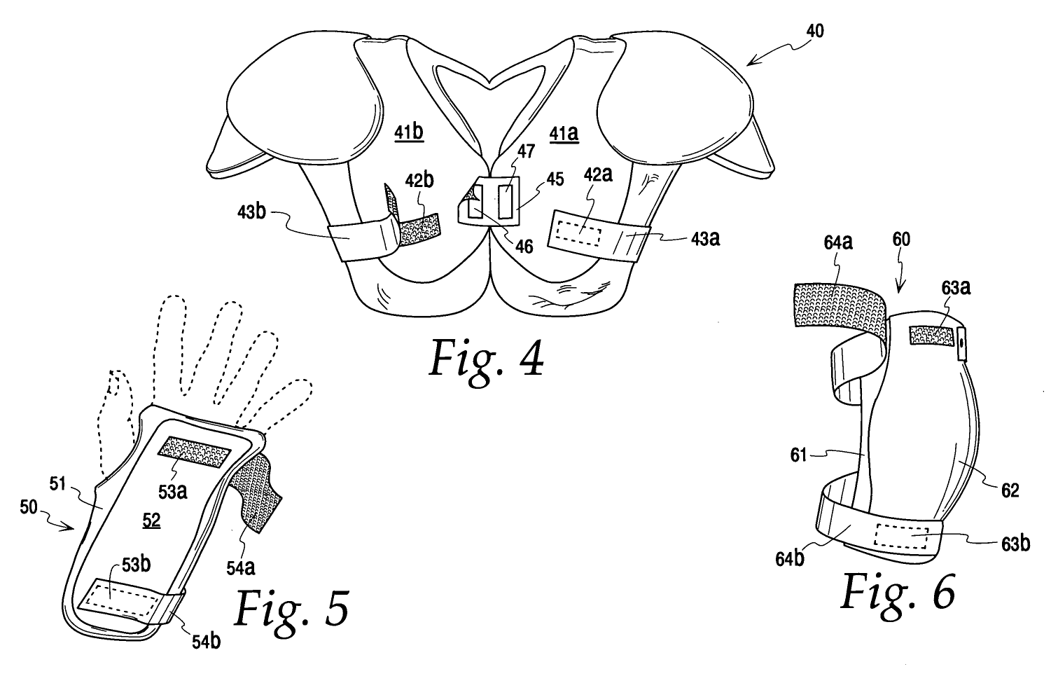

FIG. 4 illustrates an embodiment of a football shoulder pad assembly 40 having a closure system in accordance with the instant invention. Assembly 40 comprises front chest protector members 41a, 41b of molded plastic, each having a field of hooks 42a, 42b integrally molded therein at a reselected area, preferably on the front of the assembly. In the illustration of FIG. 4, loop bearing member 43a is shown in the secured position relative to field of hooks 42a, which is indicated by phantom lines as being beneath loop bearing member 43a, and loop bearing member 43b is shown in the unsecured position with respect to field of hooks 42b. Each loop bearing member 43a, 43b can be secured at its opposite end by another field of hooks, not shown, molded into the appropriate position on the rear of shoulder pad assembly 40. Alternatively, loop bearing members 43a, 43b can be bonded at their opposite ends to the rear of the shoulder pad assembly 40 by adhesives, laminating, welding, mechanical means such as rivets or stitching, or other equivalent means. Optional loop bearing member 45 can cooperate with integrally molded field of hooks 46 on front chest protector member 41b to provide a front closure for assembly 40. Loop bearing member 45 can be affixed to front chest protector member 41a by integrally molded field of hooks 47, or by other conventional attachment means as discussed above.

FIG. 5 illustrates an embodiment of a wrist guard 50 having a closure system in accordance with the instant invention. In the illustrated embodiment, wrist guard 50 includes an elastic sleeve 51 that envelops the wrist and a portion of the palm, a back molded portion 52 that extends along the back of the wrist guard, and a front molded portion, not shown, that extends along the front of the wrist and palm. Back molded portion 52 is provided with integrally molded fields of hooks 53a, 53b and corresponding cooperative loop bearing members 54a, 54b. Loop bearing member 54a is shown in the unsecured position, and loop bearing member 54b is shown in the secured position, with field of hooks 53b indicated in phantom lines. Loop bearing members 54a, 54b, can be secured at their opposite ends to appropriate locations on sleeve 51 such as by stitching, or else they may be secured to an appropriate locations on the front molded portion such as by adhesives, laminating, welding, mechanical means such as rivets, or other equivalent means.

FIG. 6 illustrates an embodiment of a knee guard 60 having a closure system in accordance with the instant invention. In the illustrated embodiment, knee guard 60 includes an soft pad 61 fitted with a hard plastic cap 62 adapted to cover the front of the knee. Plastic cap 62 is provided with integrally molded fields of hooks 63a, 63b and corresponding cooperative loop bearing members 64a, 64b. Loop bearing member 64a is shown in the unsecured position, and loop bearing member 64b is shown in the secured position, with field of hooks 63b indicated in phantom lines. Loop bearing members 54a, 54b, can be secured at their opposite ends to appropriate locations on soft pad 61 such as by stitching, or else they may be secured to appropriate locations on the cap 62 such as by adhesives, laminating, welding, mechanical means such as rivets, or other equivalent means. The loop bearing members 64a, 64b will wrap behind the leg of the user to secure the knee pad 60 in place.

Thus, there has been described a novel closure system for sports pads wherein a molded part of the sports pad has a field of hooks integrally formed in any predetermined area on the molded part for releasable engagement with a cooperative loop bearing member. In one embodiment, the hook-bearing molded part of the sports pad can be made by injection molding. The thermoplastic material used for injection-molding the integrally-formed hooks, preferably polypropylene, has a memory sufficient to cause the hooks to return substantially to their original positions after being removed from the mold and sufficient flexibility to allow the hooks to bend during removal from the mold and during release of the attached strap loops.

The hook bearing plastic molded part of the sports pads of the instant invention with a field of hooks integrally formed on a portion thereof can be made by injection molding in accordance with the methods disclosed in the aforementioned patents U.S. Pat. No. 5,368,549, U.S. Pat. No. 5,656,226, and U.S. Re. 37,338, all of which are incorporated herein by reference. As disclosed therein, the injection molded hooks will have a radius and geometry that will promote the ejection of the hooks from the injection mold, while still maintaining the desired fastening function. The hooks will straighten momentarily as they are removed from the injection mold. The injection molded component is made of a thermoplastic material that has sufficient flexibility to allow the hooks to straighten during removal from the mold and during subsequent release from a field of loops, yet has a memory sufficient to return to substantially the original hook shape and geometry. A material that is too rigid or brittle would snap off during such flexing. On the other hand, a material that is too soft would lack the structural rigidity required for the hooks to function as a fastener. Suitable thermoplastic materials include, but are not limited to, polypropylene and polyurethane materials having the desired balance of flexibility and shape memory. The polypropylene can be, for example, an unfilled polyester blend of 50% homopolymer and 50% copolymer having a melt index of 22 g/10 min and a flex modulus from 130,000 to 150,000 psi. Another suitable polypropylene material is sold by Washington Penn Plastic Company of Washington, Pa. as product PPC3CF1, having a melt flow index of 11.6 g/10 min.; a notched Izod impact strength of 3.1 ft-lbs./in., a tensile strength of 3000 psi, and a flex modulus of 163,300 psi.

Other propylene based resins that have been found suitable for use in forming molded hooks include Atofina polypropylene PPC 5660, having a melt flow index of 7, and a flex modulus of about 175,000 psi; various resins sold under the name “Pro-fax” by Basell, and having melt flow index values ranging from 18 to 35 and flex modulus values ranging from 150,000 to 200,000 psi; propylene copolymers sold by BP Amoco under the names Acclear® 8949 and Acctuf® impact copolymer 3934X, having melt flow index values of 35 and 100, and flex modulus values of 190,000 psi and 250,000 psi, respectively; resins sold by Dow Plastics under the names Inspire C703-35U and Inspire C719-35RN HP, both having a melt flow index of 35, and flex modulus values of 180,000 psi and 160,000 psi, respectively; Exxtral® BMT 106 polypropylene impact copolymer, sold by ExxonMobil Chemical, having a melt index of 8 and flex modulus of about 218,000 psi; and, long glass fiber reinforced polypropylenes sold by StaMax, resin 30YM240/10010 having a flex modulus of about 856,000 psi, and resin 40YM240/10010 having a flex modulus of about 1,140,000 psi. With long glass fiber reinforced polypropylenes having very high flex modulus values, it is believed that the glass fibers do not migrate into the hook cavities of the mold, so that the integrally molded hooks are made up of only the polypropylene component of the resin. This gives the unexpected result of a field of flexible hooks integrally molded on a surface of a very strong, rigid molded object.

Resins other than propylene based resins also can be suitable for use in the manufacture of the molded integral hooks of the present invention. Such resins can include high impact polystyrene, acrylonitrile-butadiene-styrene, nylon, high density polyethylene, linear low density polyethylene, polycarbonate, and thermoplastic olefin resins. Melt index has been found to range from 1 to 100, and flex modulus values values have been found to range from under 30,000 to over 1,138,000. The melt index values and flex modulus values that will work depend on the particular resin chosen. Specific resins include high impact polystyrene API 550 from American Polymers, having a melt flow index of 8 and a flex modulus of 280,000 psi; acrylonitrile-butadiene-styrene, including ABS 9501 UHI from Diamond Polymers, having a melt flow index of 1 and a flex modulus of about 295,000 psi, and Starex ABS SD-0150, sold by Samsung, and having a flex modulus of 420,000 psi; nylon, including Akulon® K224-PG2U Nylon 6, sold by DSM Engineering and having a flex modulus of about 580,000 psi, and Celanese nylon 6/6 1000 sold by Ticona, and having a flex modulus of about 420,000; high density polyethylene Alathon® H 5618, sold by Equistar Chemicals having a melt flow index of 18; linear low density polyethylene Petrothene® GA 564-000 sold by Equistar Chemicals and having a melt flow index of 21; polycarbonate Lexan ML4991R sold by General Electric, having a melt flow index of about 300,000; and thermoplastic olefin polymer Ecobarrier 1B00-2614 TP, having a melt index of 4 and a flex modulus of about 26,000. For polymers having such low flex modulus values, it may be necessary or desirable to use a thicker hook shape to provide a hook that is stiff enough and strong enough to provide the desired closure properties.

As further disclosed in the aforementioned patents, an apparatus for making the injection molded hook bearing component comprises a mold for forming the component, the mold having a recess in at least one predetermined area thereof, and means in the recess for simultaneously and integrally forming a field of injection molded hooks during the injection molding process. The field of hooks has a length and a width, the hooks being interspersed in both the length and width of the field. The means in the recess for forming the hooks has a plurality of hook shaped cavities. The means is in unitary assembly during the injection molding of the insert, and is maintained in unitary assembly during the removal of the injection molded insert therefrom. In a preferred embodiment, the means in the recess for forming the hooks during the injection molding process is an assembly of stacked plates, each plate having a plurality of hook shaped cavities formed in one edge thereof. In a most preferred embodiment, the plates having the hook shaped cavities alternate in the stack with plates called spacers, which have no hook shaped cavities. The spacer plates can have width less than, equal to, or greater than the plates with the hook shaped cavities.

In another embodiment, the molded plastic parts having integrally molded hooks can be made by molds in which the hooks are formed with a series of movable plates, such as shown in U.S. Pat. No. 5,615,461 of YKK Co. While such an apparatus is more complicated and costly than that described above, it can be useful in those applications in which stronger, larger hooks are desired, and in which it is not necessary for the hooks to flex during normal attachment and release of a cooperative loop bearing member from the sports pad.

In still another embodiment, the molded hooks can be included in the plastic molded parts of the sports pads as pre-made mold inserts, as described in co-pending patent application “Injection Molded Fastening Article for Use as a Mold Insert” filed on even date herewith by the same inventor and assigned to the same assignee. As described therein, a mold insert is first provided, the mold insert being an article having a field of integrally formed hooks on at least a first surface thereof, and having a second surface opposite the first surface. The insert is then fitted into a recess in a mold of the desired final article, with the first surface having the field of hooks thereon facing the mold exterior and the second surface of the mold insert facing the interior of the mold. The molding process is then carried out. The plastic of the resulting molded article surrounds the second surface of the mold insert, such that the mold insert becomes integral with the resultant molded article. The hooks of the injection molded article are protected from the heat and pressure of the mold. The molding process by which the resultant molded article is made can be injection molding, compression molding, blow molding, foam molding and other known molding techniques. The instant invention is also applicable to molding processes in which a material is dispersed inside a mold be means such as a spray gun or a trowel, as in the manufacture of fiberglass articles.

The foregoing specification describes only the embodiments of the invention shown and/or described. Other embodiments may be articulated as well. The terms and expressions used, therefore, serve only to describe the invention by example and not to limit the invention. It is expected that others will perceive differences which, while different from the foregoing, do not depart from the scope of the invention herein described and claimed. In particular, any of the specific constructional elements described may be replaced by any other known element having equivalent function.

What is claimed is:

1. An article of protective sports gear for protecting a body portion, said article being releasably securable to said body portion by a closure system, said closure system comprising an injection molded plastic member having a surface and a field of integrally molded hooks formed on a portion of said surface, said field of hooks being releasably engageable by a cooperative loop-bearing member.

2. The article of claim 1 wherein said injection molded plastic member is integral with said article of protective sports gear.

3. The article of claim 1 wherein said injection molded plastic member is a separate member attached to said article of protective sports gear.

4. The article of claim 1 wherein said hooks are flexible and said member is made from a polymer material with memory such that the hooks straighten as they are removed from the injection mold in which they are formed and resume substantially their original hook shape.

5. The article of claim 4 wherein said polymer is selected from the group consisting of polypropylene, polypropylene copolymer, glass reinforced polypropylene, high impact polystyrene, high density polyethylene, linear low density polyethylene, polycarbonate, thermoplastic olefin polymers, nylon, and acrylonitrile-butadiene-styrene.

6. The article of claim 1 wherein said article is selected from the group consisting of shoulder pads, chest pads, shin guards, knee guards, wrist guards, and elbow guards.

7. The article of claim 1 wherein said closure system further comprises a slot member having an opening through which the loop-bearing member can pass.

8. The article of claim 7 further comprising a cooperative loop bearing member affixed thereto, said cooperative loop-bearing member including a detent near one end thereof, said detent being wider than said opening so as to releasably retain said loop-bearing member within said slot member.

9. The article of claim 7 wherein said slot member is integrally formed in an injection molded plastic member of said article.

10. In an article of protective sports gear, the article being adapted to be releasably securable to a body portion by a closure system, the article of protective gear comprising a member of injection molded plastic, the improvement wherein said closure system comprises a field of hooks integrally formed on said member of injection molded plastic, said field of hooks being adapted for releasable engagement with a cooperative loop bearing member.

11. The article of claim 10 wherein said closure system further comprises a cooperative loop bearing member affixed to said article for releasable attachment to said field of hooks.

12. The article of claim 10 wherein said closure system further comprises a slot member having an opening through which said loop-bearing member can pass.

13. The article of claim 12 further comprising a cooperative loop bearing member affixed thereto, said cooperative loop-bearing member including a detent near one end thereof, said detent being wider than said opening so as to releasably retain said member within said slot member.

14. The article of claim 10 wherein said hooks are flexible and said member is made from a polymer material with memory such that the hooks straighten as they are removed from the injection mold in which they are formed and resume substantially their original hook shape.

15. The article of claim 14 wherein said polymer is selected from the group consisting of polypropylene, polypropylene copolymer, glass reinforced polypropylene, high impact polystyrene, high density polyethylene, linear low density polyethylene, polycarbonate, thermoplastic olefin polymers, nylon, and acrylonitrile-butadiene-styrene.

16. The article of claim 10 wherein said article is selected from the group consisting of shoulder pads, chest pads, shin guards, knee guards, wrist guards, and elbow guards.
